(19) United States
(12) Patent Application Publication
(10) Pub. No.: US 2004/0129906 A1
(43) Pub. Date: Jul. 8, 2004

(54) Cryogenic valve device

(75) Inventors: Franck Authelet, Vernon (FR); Michel Cramer, Douville Sur Andelle (FR); Damien Feger, Vernon (FR); Jean-Luc Pattyn, Gaillon (FR)

Correspondence Address: WEINGARTEN, SCHURGIN, GAGNEBIN & LEBOVICI LLP, TEN POST OFFICE SQUARE, BOSTON, MA, 02109, US

(73) Assignee: SNECMA MOTEURS

(21) Appl. No.: 10/738,510

(22) Filed: Dec. 17, 2003

(30) Foreign Application Priority Data
Dec. 18, 2002 (FR) 02 16064

(51) Int. Cl. F16K 31/12; F16K 1/22

(52) U.S. Cl. 251/12; 251/59; 251/305

(57) ABSTRACT

The invention provides a cryogenic valve device comprising a valve body in which a cryogenic fluid flows, and a valve member disposed in the duct and connected to a control rod for moving the valve member between a closed position and an open position so as to control the flow rate of the cryogenic fluid. The device further comprises a pneumatic actuator having a chamber containing a piston in connection with the control rod, the chamber being fed with control gas to position the piston in a determined position. The actuator is fixed to the valve body via a chamber interposed between the actuator and the valve body in such a manner as to decouple the actuator thermally from the valve body so as to maintain the temperature of the actuator, and consequently the temperature of the control gas, at a temperature that is intermediate between the temperature of the valve body and ambient temperature. The chamber is at a positive pressure so as to prevent penetration from the outside and so as to exhaust any possible leaks into the device.

### FIELD OF THE INVENTION

The present invention relates to valves for controlling the flow rate of a cryogenic fluid. The invention relates more particularly to making and implementing pneumatic actuators operating with a control gas to drive such valves.

### PRIOR ART

Pneumatic actuators using control fluids such as compressed air or nitrogen for driving cryogenic valves are offset thermally from the valve body which is at the cryogenic temperature in question, so as to ensure that the operating temperature of such actuators remains close to ambient temperature. Thus, by enabling the control gas to remain close to ambient temperature, any risk of the control gas liquefying or of crystals forming in the actuator is avoided, thus making it possible to use actuators of the same type as those which are used for non-cryogenic fluids.

However, in order to reduce the thermal connection between the actuator and the body of the valve to be controlled to a sufficient extent, and in order to provide a mechanical connection with the moving part that controls flow rate, the solution that is usually implemented consists in interposing a control rod between the actuator and the valve body, which control rod is surrounded by an insulating sheath. The control rod must be sufficiently robust to transmit control forces while nevertheless being relatively long in order to guarantee that it presents sufficient thermal resistance. This length is typically of meter order. Extending the control rod there is also the height of the actuator itself. This results in a valve device of size larger than would be needed for a non-cryogenic valve. In addition, the distance between the mass of the actuator and the axis of the pipework can lead to considerable forces being applied to the pipework, for example when the valve device is for placing in environments that are disturbed by sources of vibration, impacts, or accelerations.

Furthermore, in present-day systems, the portion of the rod that is situated outside the insulating sheath is exposed to the surrounding medium, as is the associated sealing system. This leads to risks of the exposed parts being damaged, and consequently to degraded valve operation.

In order to avoid such drawbacks, it might be envisaged to use a cryogenic pneumatic actuator that is directly adjacent to the valve body, however in order to prevent any risk of the control gas liquefying in the actuator, that makes it necessary to use one or other of the following two solutions.

The first solution consists in limiting the control pressure of the pneumatic fluid to a value lower than the saturation pressure of the control gas at the temperature of the valve. For example, when considering a valve mounted in a pipe for a flow of liquefied natural gas (LNG) at a temperature of about 111 kelvins (K), and actuated by dry nitrogen whose saturation pressure at a temperature of 111 K is 1.55 megapascals (MPa), it is necessary for the control pressure to be below this value in order to ensure that the nitrogen does not liquefy inside the actuator. This limitation is clearly penalizing since it has a direct effect on the areas of the active surfaces of the actuator, thereby increasing its dimensions, its mass, and its cost.

The second solution consists in the pneumatic fluid being a fluid whose liquefaction temperature is well below that of the valve body so as to avoid the control gas liquefying inside the actuator. In most cryogenic applications, the only solution that satisfies this requirement is to use gases that are relatively expensive, and in some cases dangerous, such as helium, hydrogen, or neon. This solution is therefore limited to applications where the requirements for reducing mass and volume are more important than requirements concerning costs, as applies for example in space applications.

In addition, when using a pneumatic actuator adjacent to the valve body, problems of control gas leaks and cryogenic fluid leaks can also appear between the actuator and the valve body and between either of them and the outside environment. Because the actuator is close to the valve body, cryogenic fluid can penetrate into the actuator. Any such penetration leads to a drop in the temperature inside the actuator and to an undesirable mixture inside the actuator between the control fluid and the cryogenic fluid. Similarly, there is a risk that a fraction of the pneumatic fluid used in the actuator might penetrate into the valve body and become mixed with the cryogenic fluid. Such pollution of the cryogenic fluid by the control fluid is naturally not desirable either. Finally, in the event of the control fluid and/or the cryogenic fluid diffusing (i.e. leaking) within the device, the fluid(s) can flow therein and escape to the outside, which can be very dangerous in certain circumstances (e.g. explosive environments).

### OBJECT AND BRIEF SUMMARY OF THE INVENTION

The present invention seeks to remedy the above-specified drawbacks and to provide a pneumatically-actuated cryogenic valve forming a compact assembly that presents reduced manufacturing and operating costs.

These objects are achieved by a cryogenic valve device comprising a valve body defining a cryogenic fluid flow duct, a shutter element disposed in the duct and connected to a control rod for moving said shutter element between a closed position in which it closes the duct and an open position in which the cryogenic fluid flows freely along the duct, thereby controlling the flow rate of the cryogenic fluid, and a pneumatic actuator comprising a chamber containing a piston in connection with the control rod, said chamber defining two cavities fed with control gas to enable the piston to be positioned in any position between the closed position and the open position of the shutter element. The actuator is fixed to the valve body via a chamber that is at positive pressure compared with the surroundings so as to maintain the temperature of the actuator at a temperature which is intermediate between the temperature of the valve body and ambient temperature and so as to isolate the internal portions of the device as a whole from the surrounding environment.

It is thus possible to use a control gas whose saturation temperature or critical temperature is equal to or greater than the temperature of the cryogenic fluid present in the duct, and to do this while limiting the offset between the actuator and the valve body. More precisely, because of the thermal decoupling provided by the presence of an intermediate chamber interposed between the actuator and the valve body, it is possible to maintain the temperature of the actuator at levels which eliminate any risk of the gas liquefying inside the actuator. In particular, if the temperature of the control gas is maintained above its critical temperature, then the pressure of the control gas can be raised to the desired value, thereby enabling the dimensions of the actuator to be reduced to a significant extent.

The intermediate chamber disposed between the actuator and the valve body constitutes a confinement volume enabling the valve body to be isolated from any leak of control gas, and conversely enabling the actuator to be isolated from any leak of cryogenic gas. To make this possible, the chamber may have an opening optionally connected to a device for recovering leaks that opens out in the vicinity of the valve device if there is no risk (pollution, explosion, . . . ), or which is connected to a duct for conveying leaks to a zone that is not sensitive or that is safe. Furthermore, the leak-recovery device may be connected to an appliance for measuring the flow rate or for analyzing the chemical composition of the gas in order to detect any malfunction of the valve and/or the actuator.

Two openings may also be provided one on either side of the intermediate chamber so as to enable said chamber to be swept with a neutral fluid which then contributes to providing thermal decoupling by convection. Excessive pressure in the event of leakage into the intermediate chamber is then also avoided.

According to a characteristic of the invention, the intermediate chamber comprises a thermally insulating spacer so as to increase thermal decoupling between the actuator and the valve body.

According to another characteristic of the invention, the actuator includes means on its outside surface for increasing the inflow of heat thereto.

According to another characteristic, the actuator includes insulating material on its outside surface to limit heat exchange between the actuator and the outside.

In a first embodiment of the invention, the pneumatic actuator is of the linear actuator type for actuating a shutter element in the form of a valve member, the piston of said actuator having a rod connected to the control rod via coupling means for transmitting linear movement to the control rod connected to the valve member so as to move the valve member between the closed position in which the valve member is in contact with a seat provided in the duct, and an open position in which the valve member is raised vertically to a distance from said seat.

In which case, the valve device may further comprise an insulating spacer disposed between the control rod and the piston rod in the vicinity of the coupling means so as to reduce heat exchange between the actuator and the shutter element (in this case the valve member).

In a second embodiment of the invention, the pneumatic actuator is of the pivoting actuator type for actuating a shutter element of the butterfly or plug type, the piston being connected to the control rod by a crank for transmitting pivoting movement to the control rod which is connected to the butterfly in such a manner as to cause the butterfly to pivot between the closed position and the open position.

In which case the valve device may further comprise an insulating spacer interposed between the control rod and the crank, and another between the control rod and the butterfly in order to reduce heat exchange between the actuator and the shutter element.

The thermal decoupling of the shutter element (valve member or butterfly) serves to avoid having a direct thermal conduction path between the shutter element and the piston of the actuator.

In addition, the piston may include first and second insulating spacers disposed respectively on either side of the point where the piston is connected to the crank so as to reduce heat exchange between the actuator and the shutter element. The crank may also be made of a thermally insulating material.

According to a characteristic of the invention, the actuator further comprises circuits for feeding the control gas, which circuits form heat exchangers with the actuator or the valve body in order to avoid any sudden drop in the pressure of the control gas when it is injected into the actuator.

The control gas may come from a specific gas source, or else it may come directly from the cryogenic fluid flowing in the duct, as in a liquefied natural gas installation, for example. In which case, the valve device further includes a pipe for taking cryogenic fluid that is connected between the duct and an opening for feeding control gas into the chamber, said pipe having means for vaporizing the cryogenic fluid that it takes, and another pipe for reinjecting control gas connected between a control gas exhaust opening of the chamber and the duct, said other pipe including means for condensing the evacuated gas.

The control gas used in the actuator may be dry nitrogen or dry air, for example.

### BRIEF DESCRIPTION OF THE DRAWINGS

Other characteristics and advantages of the invention appear from the following description of particular embodiments of the invention given as non-limiting examples and with reference to the accompanying drawings, in which:

FIG. 1A is a section view of a first embodiment of a pneumatically-actuated valve in the closed position;

FIG. 1B is a section view of a first embodiment of a pneumatically-actuated valve in the open position;

FIG. 2 is a section view of a variant of a portion of the valve shown in FIG. 1A;

FIG. 3 is a perspective view of a second embodiment of a pneumatically-actuated valve in accordance with the invention; and

FIG. 4 is a plan view of the FIG. 3 valve in section on plane III.

### DETAILED DESCRIPTION OF EMBODIMENTS OF THE INVENTION

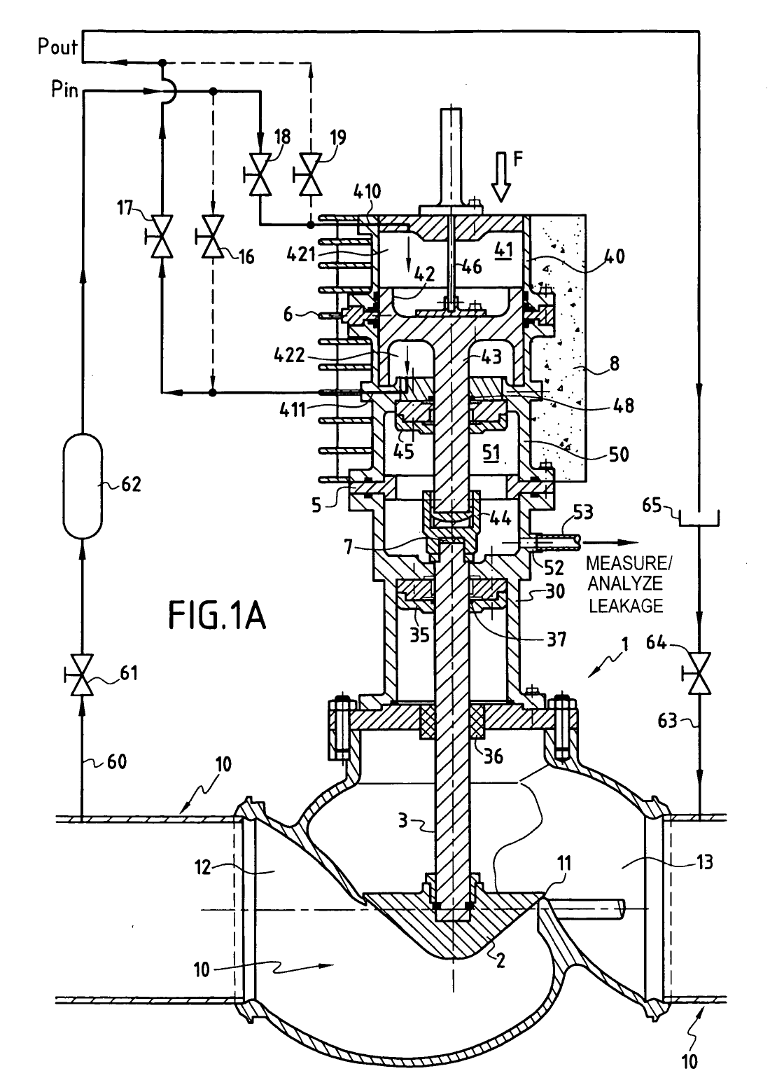

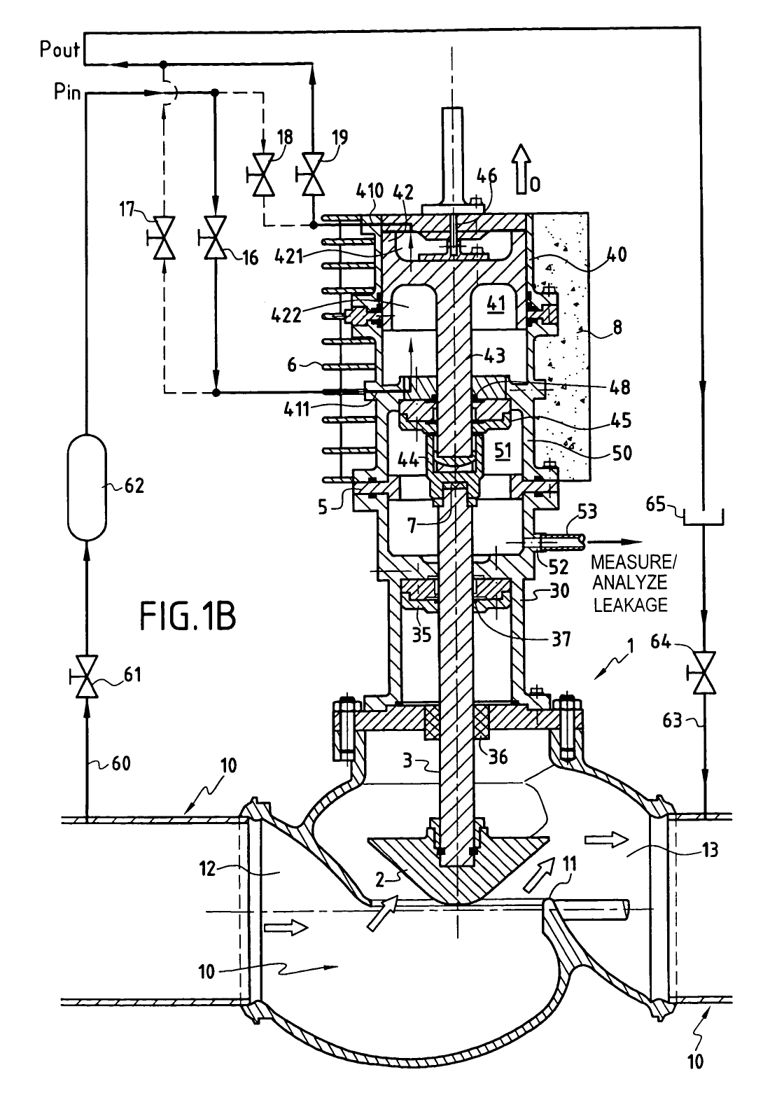

In a first embodiment of the invention, FIG. 1A shows a valve device comprising a valve body 1 constituted by a duct 10 in which there flows a cryogenic fluid, and a casing 30 fixed on the top portion of the duct. The duct 10 comprises an upstream portion 12 and a downstream portion 13 separated by a valve member 2. The valve member 2 is connected to a control rod 3 which slides vertically in guide bearings 35 and 36 to move the valve member 2 between a closed position in which the valve member rests against a seat 11 formed in the duct, and an open position in which the valve member is raised vertically above the seat (FIG. 1B). This enables the flow of cryogenic fluid along the duct to be controlled.

In order to transmit control movement to the rod 3, the valve device includes a pneumatic actuator 4. The actuator 4 is formed by a casing 40 defining a chamber 41 in which a piston 42 is movable.

The piston 42 defines a sealing “boundary” in the chamber 41 so as to define two cavities 421 and 422 of volume that is variable as a function of the position of the piston. In order to control the displacement of the piston, the chamber 41 has two openings 410 and 411 formed respectively on either side of the chamber to enable the control gas to be introduced or to escape from each of the cavities of the chamber 41. For this purpose, each of the openings 410, 411 is connected, e.g. to solenoid valves, for selectively filling or emptying the chamber cavity under consideration with control gas. More precisely, the opening 410 co-operates with two solenoid valves 18 and 19 respectively connected to a pipe Pᵢₙ for feeding control gas under pressure and to a pipe Pₒᵤₜ for exhausting control gas. Similarly, the opening 411 co-operates with solenoid valves 16 and 17 respectively connected to the pipe Pᵢₙ, for feeding pressurized control gas and to the pipe Pₒᵤₜ for exhausting control gas.

The valve is controlled by piloting the solenoid valves 16 to 19. In FIG. 1A, the valve is actuated in the closure direction (arrow F), i.e. the valve member 2 is lowered towards the seat 11 so as to reduce the flow of fluid along the duct 10. This operation is performed by opening the solenoid valves 18 and 17, enabling the cavity 421 of the chamber 41 to be fed with control gas under pressure via the solenoid valve 18, and enabling the control gas pressure present in the cavity 422 to be exhausted via the solenoid valve 17.

In order to actuate the valve in the opening direction, as shown in FIG. 1B (arrow O), it suffices to interchange the opening and closing commands applied to the solenoid valves. Thus, the solenoid valves 17 and 18 are closed while the solenoid valves 16 and 19 are open so as firstly to feed the cavity 422 with control pressure and secondly to empty the cavity 421 so as to cause the piston 42 to move towards the top of the chamber 41 and lift the valve member 2 off the seat 11.

It should be observed that any intermediate position between the closed position and the open position can be obtained with the valve device by adjusting the pressure in each of the cavities 421 and 422 by using the solenoid valves or by using any other equivalent means. By appropriately controlling the solenoid valves, it is possible to position the piston at any position between the closed and open positions in order to adjust the fluid flow rate.

The piston 42 has a rod 43 which extends vertically through a guide bearing 45 towards the valve body 1 substantially along the axis of the valve control rod 3. The free end of the piston rod 43 is connected to the end of the control rod 3 by a coupling device 44 which accommodates two movements in translation and two movements in rotation in a plane perpendicular to the axis of the valve.

The pneumatic fluid used for controlling the actuator may be a gas delivered by a specific gas source or it may be taken directly from the fluid flowing in the valve duct, as is possible in an LNG installation, for example. In which case, and as shown in FIG. 1A, the valve device has a first branch pipe 60 taking some of the fluid that flows in the duct 10 upstream from the valve. Fluid is taken off under the control of a solenoid valve 61. Since the fluid is in liquid form, the portion of the fluid that is taken is passed through an evaporator 62 in order to transform the liquid into a gas prior to injecting it into the chamber 41 (Pᵢₙ) via the solenoid valve 16 or 18. By vaporizing, the fluid rises in pressure and can be used as a control gas. Conversely, on the other side (Pₒᵤₜ), the gas which is to be exhausted is reinjected into the duct 10 downstream from the valve via a second branch pipe 63. Its flow is controlled by a solenoid valve 64 having disposed upstream therefrom a condenser 65 for transforming the gas into a liquid prior to reinjecting it. By way of example, for an LNG fluid flowing in the duct 10 at a temperature of 111 K and at a maximum pressure of 10 bars, it is possible to supply the actuator which maintained at a temperature higher than the critical temperature of methane with a control gas capable of reaching a pressure of 80 bars by virtue of evaporating.

In order to make a compact pneumatically-actuated cryogenic valve device, it is necessary to be able to control not only the amount of heat exchange that takes place between the valve body and the actuator, but also to control insulation of fluids inside the device, and insulation of the device relative to external inputs. If the actuator temperature drops to a cryogenic temperature below the saturation temperature (for a given pressure) or to the critical temperature of the control gas used, then there is a risk of condensation and liquefaction of the gas inside the actuator, which would disturb its operation. In addition, it is necessary to prevent any control gas leaking from the actuator into the valve body and conversely any cryogenic fluid from leaking into the actuator. Cryogenic fluid rising into the actuator would lead to a drop in the temperature of the control gas.

For this purpose, the valve device of the invention includes an intermediate chamber 51 formed by a casing 50. FIGS. 1A and 1B show a valve device having such a chamber. The chamber 51 is interposed between the casing 40 of the actuator and the casing 30 of the valve body in such a manner as to decouple these two elements thermally. Thus, because of the heat exchange between the actuator and the outside, the actuator is maintained at an intermediate temperature between the temperature of the valve body and ambient temperature, which intermediate temperature is above the saturation temperature or the critical temperature of the gas used for controlling the actuator.

The chamber 51 is maintained under pressure either by the presence of control gas leaks and/or cryogenic fluid leaks into it, or by an external feed device (not shown) connected to the chamber. This positive pressure protects the device from the outside environment, in particular for the purpose of preventing any moisture penetrating therein.

A first sealing barrier 26 may be placed between the intermediate chamber 51 and the casing 30 of the valve body and a second sealing barrier 48 may be placed between the chamber 51 and the casing 40 of the piston chamber 41.

The chamber 51 also has an opening 52 which may optionally be connected to a leak-recovery device 53 such as an air leak via an orifice having a check valve which serves to mitigate any failure of the positive pressure in the chamber. Excessive pressure in the event of a leak can thus be avoided. When the outside environment is not sensitive or does not present any danger (e.g. pollution or a danger of explosion) when faced with leaks of control gas and/or cryogenic fluid, the opening 52 or the leak-recovery device 53 can open out in the vicinity of the valve device. Otherwise, the opening or the leak-recovery device should be connected to a duct for conveying leaks to a zone that is not sensitive or not dangerous. In addition, it is possible to connect the leak-recovery device to an appliance for measuring flow rate or analyzing the chemical composition of the gas in order to detect any malfunction of the valve or the actuator, or indeed both of them.

Thus, by means of this intermediate chamber mounted between the valve body and the actuator, the fluid flowing in the actuator is isolated from the fluid flowing in the valve, with it being possible to convey leaks out from the device.

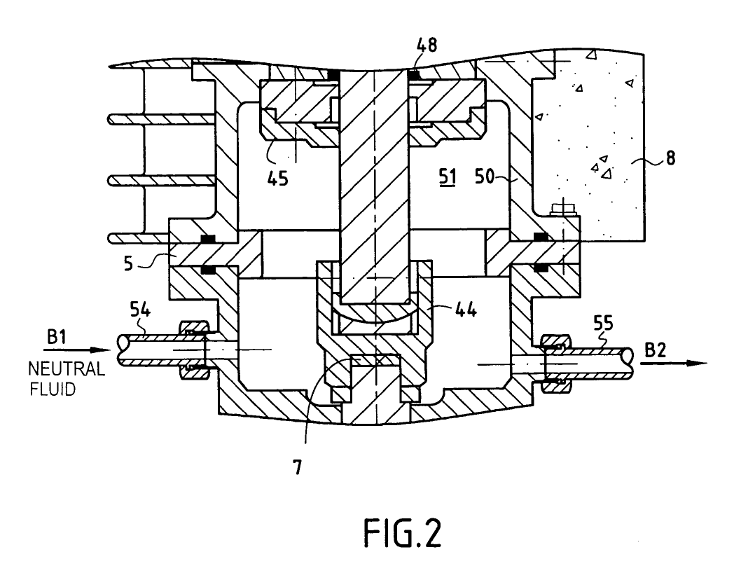

In a variant embodiment of the intermediate chamber, as shown in FIG. 2, the chamber may be provided with two openings 54 and 55. In such an embodiment, it is possible to sweep the chamber with a neutral fluid that is at a small positive pressure and at ambient temperature. This serves not only to prevent the fluid flowing respectively in the actuator and in the valve from mixing, but also enables the sweeping neutral fluid to generate forced convection between the valve and the actuator so as to increase thermal decoupling between them.

The intermediate chamber 51 may also include a thermally insulating spacer 5. The insulating spacer 5 enables thermal decoupling between the actuator and the valve body to be increased. The thickness and the material of the spacer are determined as a function of the thermal decoupling that it is desired to obtain, given the conditions of use (temperature of the cryogenic fluid, critical temperature or saturation temperature of the control gas, thermal leaks, . . . ).

An additional thermally insulating spacer 7 may also be disposed between the control rod 3 and the piston rod 43 in the coupling device 44.

Depending on circumstances, the outside wall of the actuator may be covered either in a device 6 for increasing heat exchange between the actuator and the outside, such as fins, a radiator, or the like, or else on the contrary it may be covered in an insulating layer 8 for restricting heat exchange with the actuator and thus prevent the formation of frost.

Thus, by means of the thermal decoupling between the valve body and the actuator, it is possible to reduce significantly the length of the control rod between the valve member and the actuator, since the actuator may be adjacent to the valve body, ignoring the thickness required for the intermediate chamber.

This thermal decoupling also makes it possible to take advantage of heat exchange between the actuator and the outside and heat exchange between the actuator and the valve body in order to maintain the actuator temperature in a determined range. The temperature range of the actuator may be adjusted as a function of the height of the intermediate chamber and/or, depending on circumstances, on the effectiveness of the spacer 5 and the additional spacer 7, if any. Finally, the effectiveness of the device 6 or of the insulating layer 8 serving respectively to increase or decrease heat exchange between the actuator and the outside can also contribute to adjusting the temperature range of the actuator.

By way of non-limiting example, consideration is given to a cryogenic valve mounted in a circuit having LNG fluid flowing therein at a temperature of about 111 K, which it is desired to control with dry nitrogen. If the temperature of the actuator is close to the temperature of the valve body, then the control pressure must be limited to 1.5 MPa in order to avoid the nitrogen liquefying.

In contrast, if there is any intermediate chamber 51, it is then possible to maintain the actuator temperature above the critical temperature of nitrogen, which is 126 K. Consequently, nitrogen liquefaction can be prevented whatever the control pressure. The size and the weight of the valve-and-actuator assembly can be considerably reduced compared with prior art solutions in which the actuator is located at a distance from the valve. Thus, in the present invention, the actuator can be cryogenic, i.e. it can be placed directly adjacent to the valve via the chamber 51, thereby making it possible to reduce significantly the length of the valve control rod. In addition, the actuator can be made compact by using a high control pressure since the control pressure is no longer limited by the risk of the control gas liquefying.

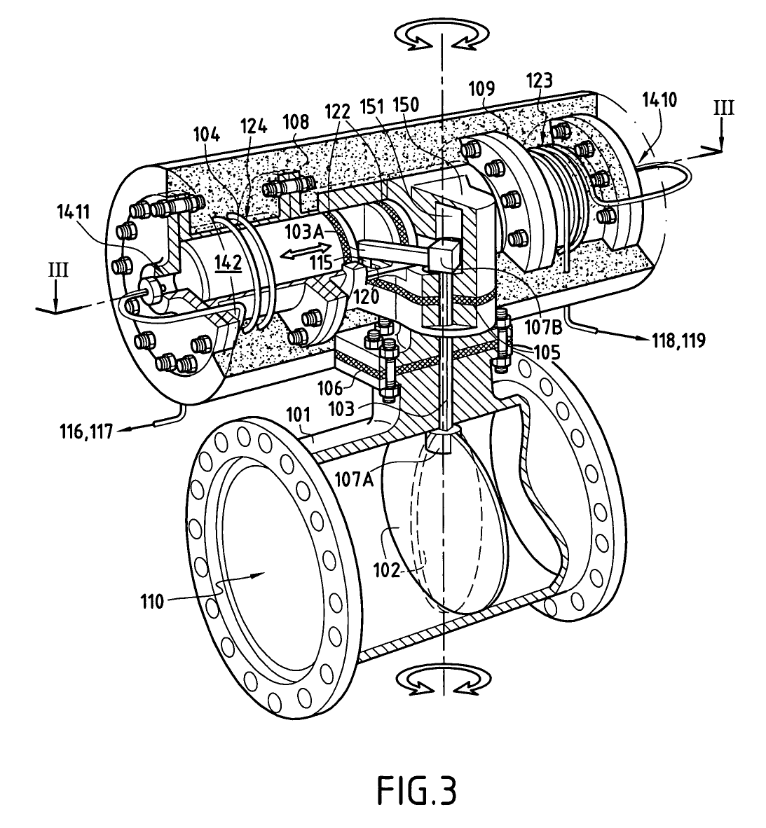

FIG. 3 shows a second embodiment of the invention applied to a valve device of the type having a rotary shutter member such as a butterfly valve, the valve device comprising a valve body 101 defining a duct portion 110 for connection in a cryogenic fluid flow circuit. A shutter element or butterfly 102 is disposed in the duct portion 110. The butterfly 102 is of dimensions substantially equal to the inside diameter of the duct 110 so as to shut it when in the closed position. The fluid flow rate in the duct 110 is controlled as a function of the extent to which the butterfly 102 is opened.

In order to be able to move the butterfly 102 between its closed and open positions, it is connected to a control rod 103 which imparts pivoting motion thereto, thereby defining the pivot axis of the butterfly.

To drive the control rod so that it pivots in order to control the butterfly 102, a pneumatic actuator 104 is placed adjacent to the valve body 101. The actuator 104 is formed by a cylindrical body 109 defining a chamber 141 in which a piston 142 moves.

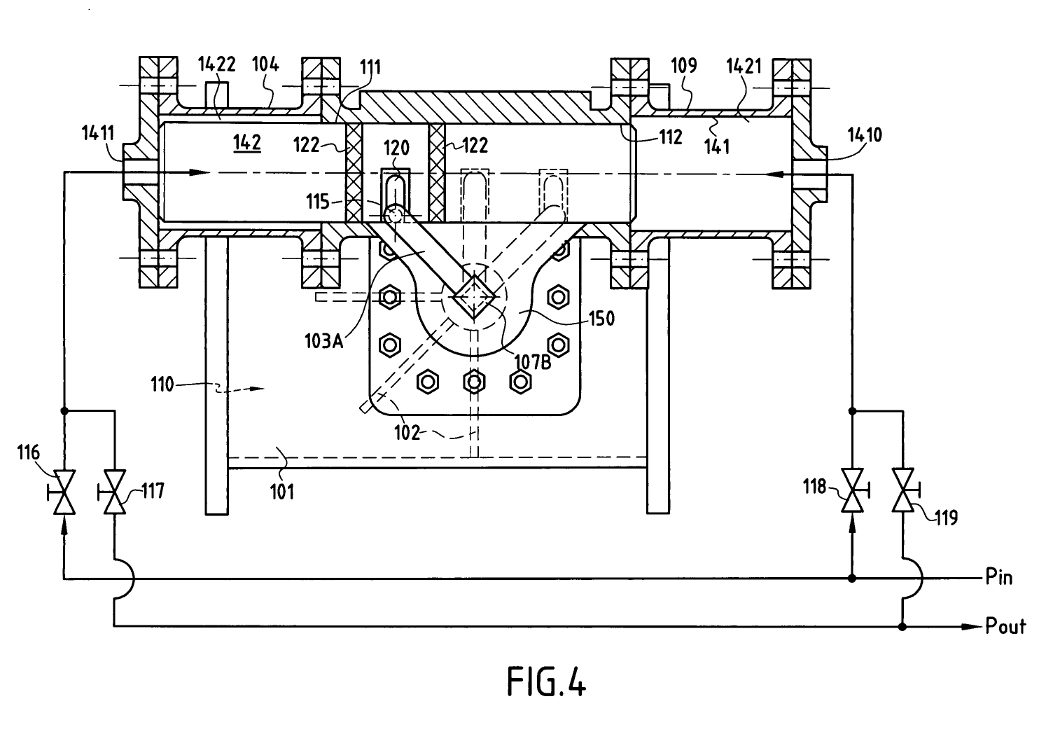

As can be seen in FIG. 4, the piston 142 separates the chamber 141 into two cavities 1421 and 1422 of volume that is variable as a function of the position of the piston. In the same manner as for the valve device described above, movement of the piston 142 is controlled by feeding and/or exhausting control gas pressure into and out from the cavities 1421 and 1422. To do this, the chamber 141 has two openings 1410 and 1411 formed respectively on either side of the chamber so as to enable control gas to be introduced into or exhausted from each of the cavities of the chamber 141. Each opening 1410, 1411 is connected to a pair of solenoid valves 118 & 119, 116 & 117 for selectively putting the portion of the chamber in question into communication with a pressurized control gas feed pipe Pᵢₙ or a control gas exhaust pipe Pₒᵤₜ.

The valve is thus controlled by piloting the solenoid valves 116 to 119, thus serving to determine the angle to which the butterfly is opened within the duct in order to control the fluid flow rate. On either side of the central portion of the actuator, there are gaskets 111 and 112 between the piston and the inside wall of the body 109 in order to prevent leakage between the cavities 1421 and 1422.

The pneumatic fluid used for controlling the actuator may be a gas delivered by a specific gas source or it may be taken directly from the fluid flowing in the duct of the valve, as is possible in an LNG installation, for example. In which case, the system for taking and reinjecting fluid (evaporator, condenser, solenoid valves) from and into the duct as described with reference to the valve device shown in FIG. 1A can be implemented in the same manner with the presently-described valve device.

Movement of the piston 102 is transmitted to the control rod 103 of the butterfly 102 via a crank 103A which serves to convert the movement in translation of the piston into pivoting movement of the control rod. For this purpose, the end of the crank 103A can be provided with an element 115 that is movable in a housing 120 in order to track the displacement of the piston and transmit pivoting movement to the control rod at its opposite end.

In order to decouple the actuator 104 thermally from the valve body 101, an intermediate chamber 151 formed by a casing 150 is interposed in the region of contact between the actuator and the valve (FIG. 3) as is the case for the valve device shown in FIGS. 1A, 1B, and 2. Consequently, because of heat exchange between the actuator and the outside, the temperature of the actuator can be maintained at a temperature that is intermediate between the temperature of the valve body and ambient temperature. The chamber 151 is maintained at positive pressure, as explained above. Similarly, it may also have an opening and possibly a leak-recovery device optionally connected to a delivery duct. Alternatively, the chamber 151 may be swept with a neutral fluid in the same manner as that described above, thereby also generating forced convection between the actuator and the valve.

Heat exchange between the actuator and the outside can also be limited by placing a spacer of insulating material 105 in the chamber 151.

By increasing the thickness of the insulating spacer by a few millimeters, which presents little penalty in terms of overall size, it is possible to increase the temperature of the actuator to levels which make it possible to extend the range of materials that are suitable for use in the sealing gaskets 111 and 112 between the piston 142 and the chamber 141. The thickness of the spacer also makes it possible to lengthen the path followed by heat between the actuator and the valve body, thereby reducing the inflow of heat from the actuator to the valve body.

If necessary, the effect of the insulating spacer 105 between the actuator and the valve body can be reinforced by adding one or more insulating spacers such as a spacer 106 interposed in the contact region between the actuator and the valve body, a spacer 107A interposed between the control rod 103 and the butterfly 102, and/or a spacer 107B interposed between the crank 103A and the control rod 103 so as to reduce heat exchange between the actuator and the butterfly 102.

Heat exchange between the actuator and the outside can be further limited by placing an insulating material 108 on the outside surface of the actuator. Alternatively, as for the actuator 4 of the first embodiment shown in FIG. 1A, a device such as a radiator or fins can be provided on the actuator so as to increase the inflow of heat thereto.

As shown in FIGS. 3 and 4, the piston 142 may be fitted with insulating spacers 122 arranged on either side of the mechanical link between the piston and the crank 103A.

Where necessary, the crank 103A may be made of a thermally insulating material.

Furthermore, if it is desired to raise the temperature of the injected gas to the temperature of the actuator, it is possible to cause said gas to pass via a heat exchanger in contact with the actuator or the valve body. In FIG. 3, two heat exchangers 123 and 124 of the coil type are disposed respectively about the actuator body 104 to enable the control gas to cool progressively prior to entering into the actuator.

These heat exchanger devices serve to avoid the control gas dropping in pressure due to its temperature dropping on being injected when control gas is injected into the chamber. Such heat exchanger devices may also be used with the actuator 4 of the valve device shown in FIGS. 1A and 1B.

Thus, the present invention makes it possible to use gases such as nitrogen or dry air for pneumatically controlling valves that operate at cryogenic temperatures, and to do so without any need to place the actuator at a distance from the valve body. This solution is particularly advantageous in installations where this type of gas is already available as is the case in most installations for transferring, storing, or liquefying gases, where dry nitrogen is needed to purge the equipment or make it inert.

For example, consideration can be given to a LNG installation in which the normal boiling temperature of the gas is 111 K. For nitrogen, this temperature corresponds to a saturation pressure of 1.55 MPa, a limit pressure for the control gas above which it begins to liquefy in the actuator if the actuator is in direct thermal contact with the valve body at the temperature of the LNG. This pressure limit has a direct impact on the design of the actuator since it then needs to present pneumatic areas that are large enough to enable it to deliver the forces needed to drive the shutter element of the valve, and that leads to the actuator being large in size.

However, if in accordance with the present invention the actuator is maintained at a temperature higher than 126.2 K, which is the critical temperature of nitrogen, then there is no risk of the control gas condensing inside the actuator, since the gas is in a supercritical state regardless of the control pressure used. This enables the control pressure to be raised to values well above the limiting pressure when the actuator is in direct thermal contact with the valve body. Consequently, it is possible to reduce significantly the mass and the size of the actuator, while still producing the same force on the shutter element of the valve.

Another aspect of the valve devices of the invention described above lies in the fact that all of the elements of the device, i.e. the valve body, the actuator, and where appropriate the intermediate chamber, are enclosed in casings that form a unit that is leaktight relative to the outside. This leaktightness between the device and the surrounding medium means that the fluids present in the device do not leak out. When the installation involves a gas that is explosive or flammable, such as natural gas, for example, the valve device of the invention can be placed near to other equipment without any fire risk. Furthermore, because of this leaktightness between the outside and the inside of the valve device, the valve can be placed or immersed in corrosive or other environments without any risk for operation of the device. In addition, the leaktightness is provided by sealing that is static, thereby further increasing the reliability of the device compared with systems that rely on dynamic sealing.

In addition to being applicable with LNG, the invention can also be applied to other cryogenic fluids such as nitrogen or oxygen, for example.

What is claimed is:

1. A cryogenic valve device comprising a valve body defining a cryogenic fluid flow duct, a shutter element disposed in the duct and connected to a control rod for moving said shutter element between a closed position in which it closes the duct and an open position in which the cryogenic fluid flows freely along the duct, thereby controlling the flow rate of the cryogenic fluid, the valve device further comprises a pneumatic actuator comprising a chamber defining two cavities and containing a piston in connection with the control rod, the cavities being fed with a control gas for positioning the piston in any position between the closed position and the open position of the shutter element, and an intermediate chamber at positive pressure relative to the surrounding pressure and disposed between the actuator and the valve body in such a manner as to thermally decouple the actuator from the valve body and isolate the actuator from the surrounding environment.

2. A valve device according to claim 1, wherein the intermediate chamber comprises a thermally insulating spacer.

3. A valve device according to claim 1, wherein the control rod further comprises a thermally insulating spacer for thermally decoupling the shutter element from the piston.

4. A device according to claim 1, wherein the actuator, the intermediate chamber, and the valve body include respective casings, said casings being interconnected in leaktight manner so as to confine the control gas and the cryogenic fluid inside the device.

5. A device according to claim 1, wherein the intermediate chamber includes an opening connected to a leak-recovery device.

6. A device according to claim 5, wherein the leak-recovery device is connected to a measuring appliance for detecting malfunction of the valve or of the actuator.

7. A valve device according to claim 1, wherein the intermediate chamber includes first and second openings to enable a sweeping fluid to flow through said chamber.

8. A valve device according to claim 1, wherein the actuator includes means on its outside surface for increasing the inflow of heat thereto.

9. A valve device according to claim 1, wherein the actuator includes insulating material on its outside surface to limit heat exchange between the actuator and the outside.

10. A valve device according to claim 1, wherein the pneumatic actuator is of the linear actuator type for actuating a shutter element in the form of a valve member, the piston of said actuator having a rod connected to the control rod via coupling means for transmitting linear movement to the control rod connected to the valve member so as to move the valve member between the closed position in which the valve member is in contact with a seat provided in the duct, and an open position in which the valve member is raised vertically to a distance from said seat.

11. A valve device according to claim 1, wherein the pneumatic actuator is of the pivoting actuator type for actuating a pivotal shutter element of the butterfly type, the piston being connected to the control rod by a crank for transmitting pivoting movement to the control rod connected to the butterfly so as to position the butterfly in an arbitrary position between the closed position and the open position.

12. A valve device according to claim 11, further comprising an insulating spacer interposed between the control rod and the crank for reducing heat exchange between the actuator and the pivotal shutter element.

13. A valve device according to claim 11, further comprising an insulating spacer interposed between the control rod and the pivotal shutter element to reduce heat exchange between the actuator and the shutter element.

14. A valve device according to claim 11, wherein the piston includes first and second insulating spacers disposed respectively on either side of a connection point between the crank and the piston to reduce heat exchange between the actuator and the shutter element.

15. A valve device according to claim 11, wherein the crank is made of a thermally insulating material.

16. A valve device according to claim 1, wherein the actuator further comprises first and second control gas delivery circuits, said delivery circuits forming heat exchangers with the actuator or the valve body.

17. A valve device according to claim 1, further comprising a pipe for taking cryogenic fluid, the pipe being connected between the duct and a control gas feed opening for the chamber, said pipe including means for vaporizing the cryogenic fluid that has been taken, and a pipe for reinjecting the control gas which is connected between a control gas exhaust opening of the chamber and the duct, said pipe including means for condensing the exhausted gas.

18. A valve device according to claim 1, wherein the control gas has a saturation temperature or a critical temperature that is substantially equal to or greater than the temperature of the cryogenic fluid present in the duct.

19. A valve device according to claim 18, wherein the control gas used in the actuator is dry nitrogen.

20. A valve device according to claim 18, wherein the control gas used in the actuator is dry air.
